(19) United States
(12) Patent Application Publication
(10) Pub. No.: US 2025/0269236 A1
(43) Pub. Date: Aug. 28, 2025

(54) METHOD AND SYSTEM FOR CLASSIFICATION AND DETECTING VARIABILITY IN MOTION PATTERNS

(71) Applicant: STMicroelectronics International N.V., Geneva (CH)

(72) Inventors: Mahesh CHOWDHARY, San Jose, CA (US); Krishna Chaitanya PALLE HAYAGREEVA, Cupertino, CA (US); Swapnil Sayan SAHA, Mountain View, CA (US)

(73) Assignee: STMicroelectronics International N.V., Geneva (CH)

(21) Appl. No.: 18/586,215

(22) Filed: Feb. 23, 2024

(51) Int. Cl. A63B 24/00; G01P 15/02; G06T 5/70; G06T 7/00; G06T 7/11; G06T 7/246; G06T 11/20

(52) U.S. Cl. CPC A63B 24/0075; G01P 15/02; G06T 5/70; G06T 7/0002; G06T 7/11; G06T 7/248; G06T 11/206; A63B 2024/0068; A63B 2220/836; G06T 2207/20021; G06T 2207/20081; G06T 2207/30168

(57) ABSTRACT

An electronic device includes a sensor unit. The sensor unit includes a sensor and low power, low area sensor processing unit. The sensor processing unit performs an unsupervised machine learning processes to learn to recognize an activity or motion of the user or device. The sensor processing unit records sensor data while the user performs the activity and generates an activity template from the sensor data. The sensor processing can then infer when the user is performing the activity by comparing sensor signals to the activity template. The sensor processing unit calculates an overall similarity metric indicating how closely the current activity matches the train the activity. The sensor processing unit outputs an indication of the similarity.

### BACKGROUND

### Technical Field

The present disclosure is related to electronic devices that include low-power sensor units, and more particularly, to sensor units that sense user and machine activity.

### Description of the Related Art

Sensors, such as inertial or optical sensors, can be utilized to capture motion trajectory of moving parts or devices for various purposes. However, this can be expensive in terms of memory and computing resources. Furthermore, even such computationally expensive techniques can result in inaccuracies based on limited field of view, occlusion of object to be tracked, or other issues.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

Embodiments of the present disclosure provide an electronic device with a sensor unit that can efficiently and effectively be trained to recognize a user or machine activity and then determine how closely the activity matches the trajectory of the trained activity.

The sensor unit includes one or more inertial sensors and a sensor processing unit. The sensors generate inertial sensor data. During training, the sensor unit learns one or more activities and generates and stores a reference template for each activity. After training, the sensor unit generates a current template when the user/machine performs an activity and recognizes/classifies the activity by matching the current template to one of the stored reference templates. After classifying the activity, the sensor unit determines how closely the current trace of the activity matches the trajectory of the trained activities and outputs a similarity metric or other type of indication of user/machine performance.

The user performance indication can greatly assist users in a large variety of applications. For example, if the sensor unit is trained to recognize a plurality of weightlifting exercises, then when the sensor unit recognizes that the user is currently performing a particular exercise, the sensor unit can indicate to the user how closely trajectory of the activity matches the motion trajectory stored during training. This can help the user recognize whether or not the user is performing the exercise with proper form or timing. Furthermore, in physical therapy settings, the sensor unit can be trained to recognize rehabilitation exercises and can provide an indication of how well the user is performing the exercises. These principles extends to recognizing when a machine is performing a certain activity and whether or not the trajectory of the activity is abnormal.

In one embodiment, a method includes generating sensor data with a sensor unit of an electronic device while the electronic device undergoes an activity and generating a current template based on the sensor data. The method includes identifying the activity by matching the current template to a reference template and generating an overall similarity metric indicative of how closely the activity matches a trained activity represented by the reference template.

In one embodiment, a method includes generating sensor data with a sensor unit of an electronic device while the electronic device undergoes an activity, generating a current template based on the sensor data, identifying the activity based on the current template, and outputting from the electronic device a rating of performance of the activity.

In one embodiment, a method includes receiving, with an electronic device, a request from a user of the electronic device to train a sensor unit of the electronic device to recognize a first motion and generating, with the sensor unit, training sensor data while the user performs the first motion. The method includes generating, with the sensor unit, a reference template for the first motion based on the training sensor data, storing the first template in a memory of the sensor unit, and generating current sensor data with the sensor unit while the user performs an activity with the electronic device. The method includes generating a current template based on the current sensor data and generating a similarity metric indicative of how closely the activity matches the first motion based on the current template and the reference template.

In one embodiment, an electronic device includes a user input, a display, and a sensor unit including a sensor. The sensor unit is configured to generate sensor data while the electronic device undergoes an activity, generate a current template based on the sensor data, and identify the activity by matching the current template to a reference template stored in the sensor unit. The sensor unit is configured to perform short-term activity matching including determining, based on the reference template and the current template, how closely the activity matches the trajectory of the trained activity represented by the reference template.

### BRIEF DESCRIPTION OF THE SEVERAL VIEWS OF THE DRAWINGS

Reference will now be made by way of example only to the accompanying drawings. In the drawings, identical reference numbers identify similar elements or acts. In some drawings, however, different reference numbers may be used to indicate the same or similar elements. The sizes and relative positions of elements in the drawings are not necessarily drawn to scale. For example, the shapes of various elements and angles are not necessarily drawn to scale, and some of these elements may be enlarged and positioned to improve drawing legibility.

FIG. 1 is a block diagram of an electronic device including a sensor unit, according to one embodiment.

FIG. 2 is a block diagram of a sensor unit, according to one embodiment.

FIG. 3 is a flow diagram of a method for training a sensor unit to recognize selected activities and to determine how closely trajectory of an activity matches a previously trained activity, according to one embodiment.

FIGS. 4A and 4B are illustrations of reference templates generated by sensor unit during training, according to one embodiment.

FIGS. 5A-5E are representations of reference templates, current templates, and heat maps generated by sensor unit, according to one embodiment.

FIGS. 6A-6E are representations of reference templates, current templates, and heat maps generated by sensor unit, according to one embodiment.

FIGS. 7A-7E are representations of reference templates, current templates, and heat maps generated by sensor unit, according to one embodiment.

FIGS. 8A-8E are representations of reference templates, current templates, and heat maps generated by sensor unit, according to one embodiment.

FIG. 9 is a flow diagram of a method for training a sensor unit to recognize a motion,

FIG. 10 is a flow diagram of a method for matching a currently performed activity with a trained activity, in accordance with one embodiment.

FIG. 11 is a flow diagram of a method for determining how closely currently performed activity matches a trained activity, in accordance with one embodiment.

FIG. 12A is an illustration of a wearable electronic device, according to one embodiment.

FIG. 12B-12D are illustrations of activities that can be performed while wearing the electronic device of FIG. 12A, according to one embodiment.

FIG. 13 is a flow diagram of a method for operating a sensor unit, according to one embodiment.

FIG. 14 is a flow diagram of a method for operating a sensor unit, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known systems, components, and circuitry associated with integrated circuits have not been shown or described in detail, to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.” Further, the terms “first,” “second,” and similar indicators of sequence are to be construed as interchangeable unless the context clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

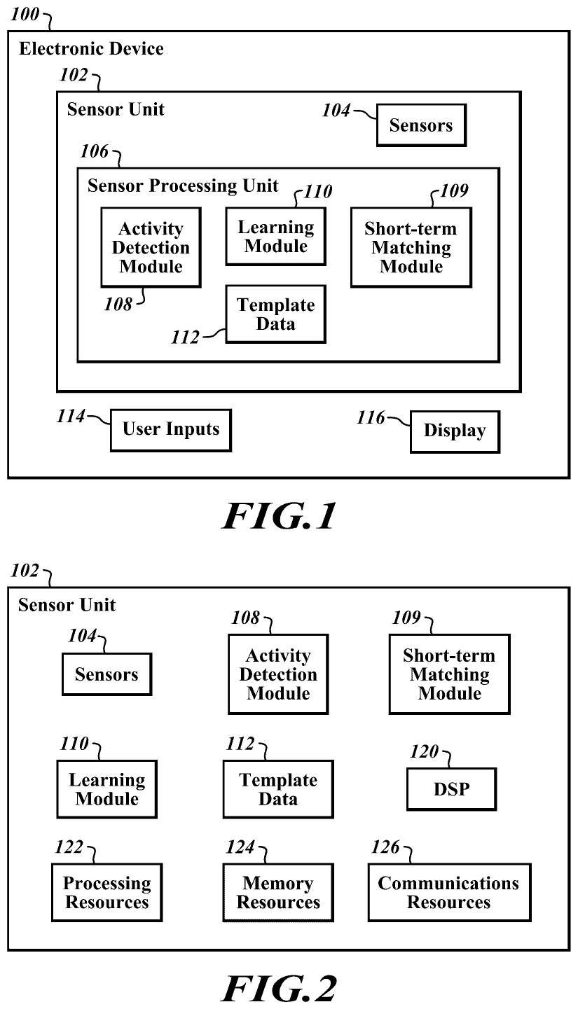

FIG. 1 is a block diagram of an electronic device 100, according to one embodiment. The electronic device 100 includes a sensor unit 102. The sensor unit 102 can generate and process the sensor data based on the motion of the electronic device 100. As will be set forth in more detail below, the components of the sensor unit 102 cooperate to effectively and efficiently learn to recognize activities or motions performed by a user of the electronic device 100, to learn to recognize the when the activities or motions are later performed, and to determine how closely the activities or motions match the training.

The following description may focus primarily on embodiments in which the sensor unit is part of an electronic device 100 that is worn, held by, or otherwise coupled to a user in order to recognize user activities and determine how closely performance of the activity matches the trained activity. However, principles of the present disclosure extend to situations in which the electronic device 100 is a machine or is coupled to a machine. Training of the sensor unit 102 can include training the sensor unit 102 to learn a plurality of activities or motions expected to be performed by the machine. After training, the sensor unit 102 can detect which activity or motion is being performed by the machine and how closely the activity or motion matches expected trajectory based on the training. This can assist in detecting abnormalities in the motions or activities performed by the machine.

In one embodiment, the electronic device 100 is a device that can be worn or held by a user. In particular, the electronic device 100 can include a smart watch, smart glasses, a mobile phone, a heart rate monitor, an exercise monitor, or other types of electronic devices. Accordingly, the electronic device 100 can include a wearable device or a device that may be held or carried by the user. Other types of electronic devices 100 can be utilized without departing from the scope of the present disclosure.

The sensor unit 102 includes one or more sensors 104. The one or more sensors 104 can include inertial sensors. The sensors 104 can include an accelerometer. The accelerometer can include a three-axis accelerometer that senses motion in three mutually orthogonal axes. Alternatively, the accelerometer can include a single-axis accelerometer or another type of accelerometer.

In one embodiment, the sensors 104 include a gyroscope. The gyroscope can include a three-axis gyroscope that senses rotation around three mutually orthogonal axes. Alternatively, the gyroscope can include a single-axis gyroscope or another type of gyroscope.

In one embodiment, the sensors 104 may include multiple accelerometers, multiple gyroscopes, an accelerometer and a gyroscope, or multiple accelerometers and multiple gyroscopes. The sensors 104 may include various types and combinations of inertial sensors.

In one embodiment, the sensors 104 include a microelectromechanical system (MEMS) sensor. Accordingly, the accelerometers and gyroscopes described above can include MEMS accelerometers and gyroscopes. A single integrated circuit die may include a plurality of MEMS accelerometers and gyroscopes. Alternatively, accelerometers and gyroscopes may be implemented in separate integrated circuit dies. While multiple sensor 104 may be present, for simplicity the description may refer to a single sensor 104.

The sensor 104 generates sensor data based on the motion of the sensors 104. The sensor 104 may initially generate analog or digital sensor signals based on the motion of the sensor 104. The sensor unit 102 may include digital signal processing circuitry that receives the analog sensor signals and generates digital sensor data based on the analog sensor signals. This can include performing analog-to-digital conversion, signal filtering, and other types of digital signal conditioning.

The sensor unit 102 includes a sensor processing unit 106. The sensor processing unit 106 receives the sensor data from the sensors and processes the sensor data. Alternatively, the sensor processing unit 106 may receive analog sensor signals from the sensors 104, convert the analog sensor signals into digital sensor data, and may then process the digital sensor data. Accordingly, unless the context dictates otherwise, description of the sensor processing unit 106 receiving sensor data from the sensor 104 can include reception of analog sensor signals from the sensor 104 and converting the analog sensor signals to digital sensor data.

The sensor processing unit 106 can include a microcontroller, a microprocessor, an integrated sensor processing unit (ISPU) or another type of processing circuitry. In one example, the processing unit 106 includes a low power, low area microcontroller with a relatively small amount of memory. The memory can include flash RAM, SRAM, DRAM or other types of memory.

In one embodiment, the sensor unit 102 is configured to perform an on-device and online machine learning process to learn to recognize a motion or activity of the user. More particularly, the sensor processing unit 102 is configured to learn to recognize a motion or activity of the user as user wears, holds, or otherwise carries the electronic device 100. As the user performs the motion, the electronic device 100 will also be moved. The sensor 104 will generate sensor data as the electronic device 100 moves with the motion of the user. The sensor unit 102 can perform an online or on-device machine learning process to recognize the motion or activity of the user.

The sensor processing unit 106 includes an activity detection module 108, a short-term matching module 109, and a learning module 110. While FIG. 1 illustrates the activity detection module 108, the short-term matching module 109, and the learning module 110 as separate modules, in practice, the activity detection module 108, the short-term matching module 109, and the learning module 110 may correspond to a single module or algorithm.

The learning module 110 is configured to learn new activities or motions of the user so that the sensor processing unit 106 can later infer when the user is performing the learned activities or motions and can determine how closely performance of the activity or motion matches the trained activity or motion. The learning module 110 can be implemented utilizing processing resources and memory resources of the sensor processing unit 106. The learning module 110 can be implemented using firmware or other configuration data executed or implemented by the sensor processing unit 106. The learning module 108 can also include dedicated circuitry for learning new activities or motions of the user/device.

Before further describing the learning model 110, it is beneficial to discuss other components of the electronic device 100. The electronic device 100 includes user inputs 114. The user inputs 114 can include mechanisms or functionality that enables the user to provide inputs, commands, or responses to the electronic device 100. The user inputs 114 can include a touchscreen, a button, a slider, a dial, keys, or other types of functionality that enable a user to provide inputs, commands, responses, or to otherwise control the electronic device 100. In one embodiment, the user inputs 114 can include wireless communication circuitry that enables the electronic device 100 to communicate with other devices. The user may input commands, responses, or other inputs to the electronic device 100, by transmitting such commands, responses, or inputs from another electronic device wirelessly coupled to the electronic device 100. Various other types of user inputs 114 can be utilized without departing from the scope of the present disclosure.

The electronic device 100 includes a display 116. The display 116 can include any circuitry or functionality that enables the electronic device 100 to provide information to the user. The display 116 can include a screen that can display images or text to the user. The display 116 can include indicator lights that can provide indications of the functionality of the electronic device 100 based on illumination schemes of the indicator lights. The display 116 can include speakers or other audio devices are able to provide information audibly to the user. The display 116 can include any other type of mechanism of functionality that enables the electronic device to provide information to the user. The electronic device 100 can also provide information to the user by transmitting information to an electronic device wirelessly coupled to the electronic device 100 so that the other electronic device can display the information to the user.

Returning to the learning module 110, the sensor processing unit 106 can utilize the learning module 110 to learn a motion or activity of the user. In one embodiment, the learning module 110 can be utilized to generate templates for repetitive exercises that are demonstrated in a doctor's office or physical therapy office so that a patient can perform these exercises at home. Accordingly, during training or learning, the user may perform motions under direction or control of medical, therapy, or training personnel that are demonstrating proper technique or motion. Reference templates can be generated during these conditions. As will be set forth in more detail below, the short-term matching module 109 can provide feedback to the user indicating how well the user is performing a motion or exercise based on the reference templates.

Motions or activities that can be learned can include range of motion exercises. These exercises can help to increase the range of motion and joints. These can be done with or without weights. Movement of arms, elbows, wrists, or limbs can be tracked against reference specified by medical or therapy personnel. Range of motion exercises can include neck tilting and rotating exercises, shoulder raising and lowering exercises, elbow bending exercises, wrist exercises such as opening and closing hands or fingers or making rotating motions with the wrist, hip exercises such as raising or lowering the legs, the exercises such as bending and straightening the knees, ankle exercises such as pointing and flexing toes or rotating the ankles.

The activities or motions can include strength training exercises that help to build muscle strength. The strength training exercises can include weightlifting exercises, resistance band exercises, or body weight exercises. The strength training exercises can include exercises prescribed for rehabilitation after a stroke or injury. The strength training exercises can include push-ups, squats, triceps dips, bicep curls, leg raises, lat pull-downs, or other types of exercises.

The activities or motions can include balance exercises that can be done standing, sitting, or lying down. The motions or activities can include coordination exercises involving past success catching a ball, throwing the ball, or walking on the balance beam.

In one embodiment, the user can provide, via the user inputs 114, an indication that the user would like the sensor unit 102 to learn a new activity or motion. The sensors 104 generates sensor data while the user performs the activity or motion. The learning module 110 records and processes the sensor data. The learning module 110 learns characteristics of the motion or activity by processing the sensor data collected during the motion or activity. The learning module 110 can utilize on-device or online machine learning processes to learn the new activity or motion based on the sensor data.

In one embodiment, the learning module 110 generates a reference template for the new activity or motion. In particular, the learning module 110 processes the sensor data utilizing one or more on-device or online machine learning processes to generate a template based on the sensor data. The template can include a heat map. The heat map can include a distribution of inertial sensor data values that characterize the motion or activity. In one embodiment, the benefit of a heat map template is that the timing or sequence of the inertial sensor data values associated with the activity may not be taken into account. This results in templates that take up very little memory while enabling recognition of the activity or motion in the future. As used herein, templates generated during the learning or training process may be referred to as reference templates.

The sensor processing unit 106 can include template data 112. The template data can be stored in memory and can include a plurality of reference templates. Each template corresponds to a different activity or motion that has been learned by the learning module 110.

In one embodiment, the sensor processing unit 106 may be preloaded with a plurality of learned activities. The learning module 110 can be configured to fine-tune the preloaded learned activities based on sensor data. In particular, as the user wears, holds, or carries the electronic device 100, the sensor processing unit 106 can recognize when the user is likely performing a preloaded activity and can adjust parameters of the preloaded activity. In this way, the learning module 110 can individualize previously learned or preloaded activities based on specific characteristics of the motion of the user. For example, the learning module 110 can adjust preloaded or previously learned templates based on the sensor data associated with the user.

In one embodiment, the user can provide an input to the electronic device 100 indicating that the user would like the electronic device 100 to learn a new activity or motion of the user. The learning module 110 can receive and analyze sensor data associated with the new activity or motion. The learning model 110 can generate a new template based on the new activity or motion.

In one embodiment, after the user indicates that a new activity or motion should be learned, the learning module 110 can request that the user momentarily remain stationary before beginning the new activity or motion. When the learning module 110 detects that the user has been stationary for a selected duration the learning module 110 begins recording sensor data associated with the new activity or motion. The learning module 110 can then analyze the new activity or motion and can learn the new activity or motion. Learning an activity or motion can include adjusting parameters of the activity detection module 108. Learning the new activity or motion can include generating a new template or adjusting the previously generated template.

In one embodiment, after the user indicates that a new activity or motion should be learned, the learning module 110 can automatically segment the recording sensor data without the user needing to momentarily remain stationary before beginning the new activity or motion. The learning module 110 may use automatic segmentation algorithms to extract the new activity or motion from the sensor data.

The sensor processing unit 106 includes an activity detection module 108. The activity detection module 108 is utilized during standard operation of the sensor unit 102 after generating the reference templates. When a user is performing a motion or activity, the activity detection module 108 generates one or more current templates. The current templates can be generated in a same manner as generation of the reference templates, except that generation of the current templates is performed without prompting or instruction from the user.

The activity detection module 106 can continuously or periodically analyze sensor data from the sensor 104 in order to determine if the sensor data corresponds to one of the activities previously learned by the learning module 110. If the activity detection module 108 detects or infers that the user is performing a previously learned activity or motion, then the activity detection module 108 can generate an output indicating that the user is performing the previously learned activity or motion.

In one embodiment, the activity detection module 108 corresponds to a classifier model. In particular, the activity detection module 108 can correspond to a classifier that analyzes sensor data and outputs a classification based on the sensor data. The activity detection module 108 can output one of a plurality of classes. The activity detection module 108 can have a class for each learned activity or motion. The activity detection module 108 can also have a class indicating that the sensor data does not correspond to any of the previously learned activities or motions. Accordingly, in one embodiment, if there are n learned activities, the activity detection module 108 may have n+1 possible classifications because there is a classification for each of the n learned activities and an additional classification indicating that the sensor data does not match any of the previously learned activities.

The activity detection module 108 may correspond to an algorithm implemented with processing and memory resources of the sensor processing unit 106. The algorithm may be generated, adjusted, or updated by the learning module 110. The algorithm may be preloaded in the sensor processing unit 106. The algorithm may then be updated or adjusted by the learning module 110.

In one embodiment, the activity detection module 108 infers that the user is performing one of the learned activities by comparing a current template generated using new sensor data to the reference templates in the template data 112. Such a comparison can include generating a current template based on the new sensor data and comparing the current template to the template stored in the template data 112. If the new template matches any of the previously generated templates within a threshold tolerance, then the activity detection module 108 can infer that the user is performing the action corresponding to the matched template.

In one embodiment, the sensor processing unit 106 includes a short-term matching module 109. The short-term matching module 109 is utilized once the activity detection module 108 has detected that the activity or motion currently being performed by the user corresponds to one of the trained activities or motions as represented by the reference templates. In other words the short-term matching module 109 is utilized after the activity detection module 108 has matched a current template to one of the reference templates.

In one embodiment, the short-term matching module 109 determines how closely the current activity matches the reference activity. The short-term matching module 109 generates a similarity metric indicating how similar the current template is to the matched reference template. The short-term matching module 109 provides data indicating to the user how closely trajectory of the current activity matches the reference activity. This can then be utilized by the user to adjust trajectory of the activity or motion to more closely match the trained motion.

The similarity indication provided by the short-term matching module 109 can be highly beneficial. For example, if the user is performing physical therapy exercises at home for which the sensor processing unit 102 is trained under supervision of medical, therapy, or training personnel, then the similarity indication provided by the short-term matching module 109 can be utilized to help ensure that the user performs the exercises properly. If the user is performing weightlifting exercises in which proper form is important in order to avoid injury, then the similarity indication provided by the short-term matching module 109 can help the user to adjust their form. Further details regarding the generation of reference templates, activity matching, and short-term matching are provided below.

In one embodiment, the electronic device 100 includes processing, memory, and communication resources other than the sensor unit 102. The electronic device 100 may implement one or more software applications. The one or more software applications can include an exercise tracking application. The exercise tracking application can communicate with the sensor unit 102. For example, when the sensor unit 102 recognizes that the user is performing a previously learned activity or motion, the sensor unit 102 can output data to the exercise tracking application indicating that the user is performing the previously learned activity or motion. The sensor unit 102 can also provide repetition counting data or other activity tracking data to the exercise tracking application. The exercise tracking application can then make a recording utilizing the data from the sensor unit 102. The exercise tracking application can then output data to the user.

In one embodiment, the sensor unit 102 utilizes very little memory and processing resources. For example, the entire activity detection module 108 and the learning module 110 can be implemented with less than 10 kB of SRAM and less than 30 kB of flash RAM. This is significantly less than traditional sensor unit step may utilize more than 65 kB of SRAM and 500 kB of flash RAM.

Furthermore, the activity detection algorithm can modify information about existing motion primitives according to user motion characteristics. This makes the algorithm robust to domain shifts across users. Other possible solutions are static and lack on-device training capabilities.

While descriptions herein primarily address a sensor unit that utilizes on-device or online learning to recognize actions of a user, principles of the present disclosure extend to learning other types of activities. For example, the sensor unit can be coupled to an electronic device such as a machine or vehicle. The sensor unit 102 can utilize unsupervised learning to learn one or more operational modes of the machine utilizing principles described above. This can be utilized to detect when the machine is operating anomalously or to merely detect the current operational mode of the machine.

In one embodiment, the machine includes one or more moving parts or is a machine that otherwise moves during its operation. The machine can include an industrial machine, a machine that moves material from one location to another, or a machine that processes material, a vehicle, or other types of machines or devices. In one embodiment, the machine can include a household appliance such as a coffee maker, a washing machine, a dryer, a dishwasher, a mixer, a blender, a microwave oven, or other types of machines. Moving parts can include a fan, a motor, a servo, wheels, or other types of moving parts. Principles of the present disclosure can also extend to machines or electronic devices that do not include moving parts.

In one embodiment, the machine includes one or more standard operating modes. The machine may operate in various operating modes at different times. For example, an industrial machine may have a material receiving mode in which material is loaded into the industrial machine. The industrial machine may have a transport mode in which the industrial machine moves material from one location to another on a track. The industrial machine may have a rotational load in which the industrial machine performs a rotation. The industrial machine may operate in any of these modes at different times. Each of these modes may have characteristic movements. As another example, a blender may operate in a plurality of modes such as a puree mode, a smoothie mode, various blending speed modes, or other types of modes. The blender as a whole, or the blender's moving parts may have different characteristic motions in the various operating modes.

During the lifetime of the machine, the machine may deteriorate or breakdown. For example, a moving part within the machine may begin to deteriorate. Often such deterioration is not noticeable until a serious breakdown occurs. The breakdown may ruin expensive parts or may entirely ruin the machine. It is beneficial to detect deterioration before serious damages occur. Such detection can enable inspection, maintenance, or repair before serious damage or destruction can occur.

Deterioration of a machine may manifest in slight changes in the motion of the machine or the motion of moving parts in the machine. For example, a motor may rotate more slowly, normally smooth motion may become rough or jittery, or other phenomenon may occur that is difficult to detect with human senses. Replacing machines with a machine that comes pre-equipped with an expensive sensing device may be cost prohibitive or otherwise unfeasible.

Using principles described above, the sensor unit 102 can detect anomalous behavior of the machine and output a warning or other indication that the machine should be inspected. The sensor unit is highly sensitive and can detect very small changes in operation. The small changes in operation may be indicative of deterioration of the machine or imminent breakdown. The sensor unit can detect such small variations long before they would be apparent to human senses. When the sensor unit 102 outputs a warning or indication of anomalous behavior, technicians can inspect the machine and can perform maintenance, repair, or part replacement before serious damage is done to the machine.

Accordingly, throughout the description, when reference is made to learn a new activity of a user, such principles extends also to learning operational modes of machines or vehicles. Furthermore, principles of the present disclosure can be utilized to recognize hand gestures in augmented reality (AR)/virtual reality (VR) applications, fall detection in healthcare applications, or other types of activities or operations associated with an electronic device.

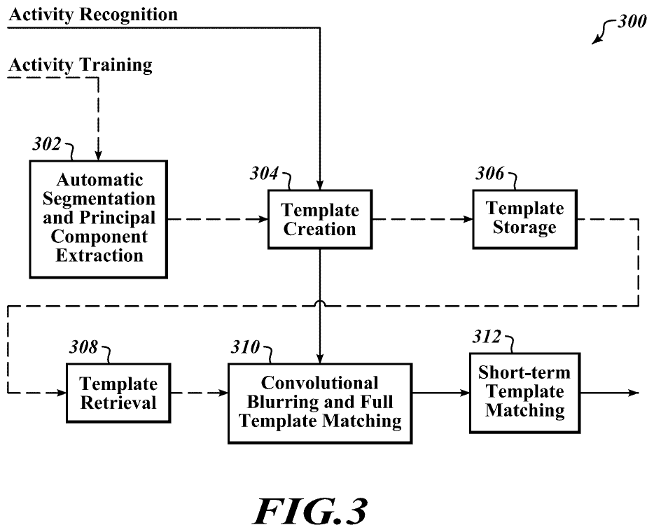

FIG. 2 is a block diagram of a sensor unit 102, according to one embodiment. The sensor unit 102 of FIG. 2 is one example of a sensor unit 102 of FIG. 1. The sensor unit 102 includes one or more sensors 104. The one or more sensors 104 can include one or more inertial sensors such as accelerometers, gyroscopes, or other types of sensors.

The sensor unit 102 may include one or more digital signal processors (DSP) 120. The DSP 120 may be in an ASIC associated with the sensors 104. Alternatively, the DSP 120 may be part of a sensor processing unit 106. The DSP can convert analog sensor signals to digital sensor signals and can otherwise condition the sensor signals for processing by a sensor processing unit 106.

The sensor unit 102 may include processing resources 122. The processing resources 122 can include one or more microcontrollers, one or more microprocessors, one or more ISPUs, or other types of processing resources. In one embodiment, the processing resources 122 correspond to a low power, low area microcontroller.

The sensor unit 102 includes memory resources 124. The memory resources 124 can include one or more buffers, registers, SRAM arrays, DRAM arrays, flash memory arrays, or other types of memory that can store data and that can be read by the processing resources 122. The memory resources 124 may store software instructions for implementing functionality of the sensor unit 102 including the sensor processing unit 106. The memory resources 124 may store data corresponding to an algorithm or analysis model associated with the learning module 110 and the activity detection module 108. The memory resources 124 may store one or more templates associated with a learned activity or motion. The memory resources 124 may store one or more temporary templates associated with sensor data utilized for inferring or classifying the sensor data as corresponding to one of the learned activities.

The sensor unit 102 may include communication resources 126. The communication resources 126 can include circuitry for transmitting signals or data between components of the sensor unit 102, between the sensor unit 102 and components of the electronic device 100, or between the sensor unit 102 and a device external to the external device. Accordingly, the communication resources 126 may include circuitry protocols for wired transmission, wireless transmission, or other types of transmissions.

The sensor unit 102 includes a learning module 110. The learning module 110 can correspond to an algorithm implemented with the processing resources 122 and the memory resources 124. In particular, the learning module 110 may be implemented by the processing resources 122 executing instructions stored in the memory resources 124. The learning module 110 may perform actions described in relation to FIG. 1. In particular, the learning module 110 may utilize on-device or online machine learning processes to learn motions or activities of a user of the electronic device 100.

The sensor unit 102 may include an activity detection module 108. The activity detection module 108 can correspond to an algorithm implemented with the processing resources 122 and the memory resources 124. In particular, the activity detection module 108 may be implemented by the processing resources 122 executing instructions stored in the memory resources 124. The activity detection module 108 may correspond to a classifier or other type of analysis model that analyzes sensor data and classifies the sensor data as corresponding to one of the learned activities or motions.

The sensor unit 102 may include a short-term matching module 109. The short-term matching module 109 can determine how similarly the inferred motion is being performed in comparison to the trained motion or activity.

Although the activity detection module 108, the short-term matching module 109, and the learning module 110 are illustrated as separate modules, in practice, the activity detection module 108, the short-term matching module 109, and the learning module 110 may be a single module or algorithm. The learning module corresponds to the algorithm generating new templates based on sensor data. The activity detection module 108 corresponds to the algorithm generating temporary templates based on the sensor data and matching the temporary templates to previously stored templates. The short-term matching module 109 corresponds to the algorithm identifying how similarly the motion has been performed to a trained motion.

The sensor unit 102 includes template data 112. The template data 112 may correspond to reference templates that were previously generated during training. The template data 112 may be stored in the memory resources 124. In one embodiment, the template data 112 is stored in a flash memory of the memory resources 124. The sensor unit 102 may include other components and other arrangements of components than shown in FIG. 2, without departing from the scope of the present disclosure.

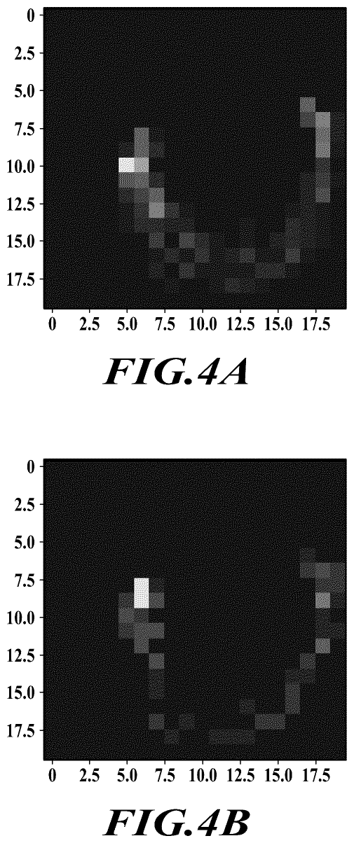

FIG. 3 is a flow diagram of a method 300 for operating a sensor unit, according to one embodiment. The method 300 can utilize components, systems, and processes described in relation to previous and subsequent figures. The method 300 includes aspects of training a sensor unit 102 to learn new motions or activities. Training aspects are represented by dashed lines. The method 300 includes aspects related to inferring or classifying a current activity and determining how similarly the current activity is being performed in comparison to a trained activity.

At 302, activity segmentation and principal component instruction are performed. Activity segmentation can include receiving from the user, a request to learn a new activity. The sensor unit may prompt the user, via a display of an electronic device, to perform the activity. Initially, the sensor processing unit may record sensor data for a duration of time corresponding to activity window. However, key characteristics of the motion or activity may be determined utilizing only a portion of the selected window of time.

As it is beneficial to detect variability in the inference window (activity detection) with respect to the reference template, it is beneficial to do a match with the time aligned component of the motion in the reference template. Accordingly, reference templates are created from the buffer having a same size as the inference window. However, the actual training window may be larger than the inference window in order to allow capturing larger amounts of information and ignoring static values.

Accordingly, after filling the reference template buffer, a portion size of the sensor data is selected equal to the inference window. The portion that is selected is the portion having the greatest variance/information content. The reference template is generated from this portion. This is called automatic segmentation via principal component extraction.

As one example, the training window may be 10 seconds in length. However, the inference window during which current templates are generated during detection may be only three seconds in length. The automatic segmentation and principal component extraction identify the three seconds from the training window for which the variance/information content is greatest. This three second portion of the sensor data from the 10 second training window will be utilized to generate the reference template.

At 304, the sensor unit generates a reference template based on the selected portion of the sensor data (e.g., the portion with the highest variance). In one embodiment, the reference image is generated from timeseries accelerometer data. The accelerometer data includes X axis accelerometer data (ax,t), Y axis accelerometer data (ay,t), and Z-axis accelerometer data (az,t). The gravity vector swing includes X axis gravity swing values (gx,t), Y axis gravity swing values (gy,t), and z-axis gravity swing values (gz,t). First, the gravity vector swing from roll (ϕt) and pitch (θt) is calculated from the accelerometer samples. The role and pitch in the gravity swing vector are calculated in the following manner:

$$\{ \begin{matrix}{g}_{x , t} = sin {θ}_{t} \\ {g}_{y , t} = cos {θ}_{t} sin {ϕ}_{t} \\ {g}_{z , t} = cos {θ}_{t} cos {ϕ}_{t}\end{matrix} \{ \begin{matrix}{ϕ}_{t} = arc tan 2 ( {a}_{y , t} , {a}_{z , t} ) \\ {θ}_{t} = arc sin \frac{{a}_{x , t}}{\sqrt{{a}_{x , t} + {a}_{y , t}^{2} + {a}_{z , t}^{2}}}\end{matrix}$$

Next, the two swing axes with maximum variance/information content are selected. The reference template is created from the two selected axes. In one embodiment, generating the reference template corresponds to creating a quantized image template. The quantized image template provides an efficient and spatial view of the motion primitives. In one embodiment, the quantized image template g^{quantized}_{u,t} can be generated in the following manner:

$${g}_{u , t}^{quantized} = 0.5 ( Δ \cdot i + Δ \cdot ( i - 1 ) ) ⇔ ( {g}_{n , t} < Δ \cdot i ) ⋀ ( {g}_{u , t} > Δ \cdot i - 1 )$$

$$Δ = \frac{max ( {g}_{v} - min ( {g}_{v} )}{m - 1} , v = \{ a , b \}$$

A peak detector is also activated, which counts the number of repetitions in the current window. The peak detector identifies a point as a peak if it has the maximal value and was preceded to the left by a value lower by DELTA. The peak detector operates on the accelerometer axis v[ ] which has maximum variance out of x, y and z.

At 306, the sensor unit 106 stores the reference template in memory. This can correspond to writing the reference template to a flash memory of the sensor unit 102.

During the activity recognition/inference portion of the process, at 304 the sensor processing unit 106 generates a current template. In other words, after the reference templates have been generated, the sensor processing unit 106 is ready to perform recognition/inference of activities or motions performed by the user of the electronic device 102. During the activity recognition portion of the process, the sensor processing unit 106 creates a current template corresponding to the current motion or activity in the same manner as creating the reference templates, as described above, aside from selecting the portion with greatest overall variance.

At 310, after the current template has been created, template blurring and template matching are performed. This can include retrieving one or more reference templates at 308 so that the current template can be matched to one of the reference templates.

When a current template is compared to a reference template, convolutional blurring may be performed as part of the matching process. The convolutional blurring can be performed on either or both of the current template and the reference template. The convolutional blurring corresponds to spreading data values from high value portions of the template to adjacent portions of the template. This can help ensure that minor offset differences in the templates do not prevent proper matching of an activity to a reference template. Convolutional blurring can be performed in the following manner:

ω_{blurred}=ω*Jₖ,ω={e,f}

where w is a template (corresponding to either a reference template e or a current template f) and Jk is a blurring kernel used in the convolutional blurring operation.

After blurring of the reference template and/or the current template, the sensor processing unit 106 determines whether or not the current template is a match for the reference template. In other words, the sensor processing unit 106 determines whether or not the current template represents the same activity as the reference template.

In one embodiment, the sensor processing unit utilizes the universal image quality index to match the current template to a reference template. The universal image quality index is calculated between the current template and the reference templates. The reference template e for which the similarity metric of the current template f is maximum is selected as the class of the current template. The similarity metric Q can be given with the following relationship:

$$Q = \frac{{σ}_{ef} \cdot \overline{e} \cdot \overline{f}}{( {σ}_{c}^{2} + {σ}_{f}^{2} ) \cdot ( {\overline{e}}^{2} + {\overline{f}}^{2} )}$$

where σ²ₑ is the variance of original image e, σ²_{f} is the variance of original image f, and σ_{ef} is the cross variance between e and f, ē is the mean of e, and f̅ is the mean of f. For templates with dimensions m×m, σ²ₑ, σ²ₑ, σ_{ef}, ē and f̅ are given by the following formulas:

$$\overline{e} = \frac{1}{{m}^{2}} {\sum }_{i = 1}^{{m}^{2}} {e}_{i} , \overline{e} = \frac{1}{{m}^{2}} {\sum }_{i = 1}^{{m}^{2}} {f}_{i}$$

$${σ}_{e}^{2} = \frac{1}{{m}^{2} - 1} {\sum }_{i = 1}^{{m}^{2}} ( {e}_{i} - \overline{e} ) , {σ}_{f}^{2} = \frac{1}{{m}^{2} - 1} {\sum }_{i = 1}^{{m}^{2}} ( {f}_{i} - \overline{f} )$$

$${σ}_{e , f} = \frac{1}{{m}^{2} - 1} {\sum }_{i = 1}^{{m}^{2}} ( {e}_{i} - \overline{e} ) \cdot ( {f}_{i} - \overline{f} )$$

The sensor processing unit 106 can select as a match the reference template with the highest universal image quality score with respect to the current template, assuming that reference template has a universal image quality score greater than a threshold universal image quality score. Other ways of matching templates or otherwise classifying the reference template can be utilized without departing from the scope of the present disclosure.

At 310, the processing unit 106 performs short-term template matching between the current template and the matched reference template. The short-term matching enables the sensor processing unit 106 to determine how similarly the action or motion is being performed with respect to the trained action or motion represented by the matched reference template.

In one embodiment, multiple metrics are utilized to perform the short-term template matching. Prior to utilizing the multiple metrics, the sensor processing unit 106 first flattens the current template and the matched reference template and divides the templates into a predefined number of chunks or portions. For each chunk, if all of the values are zero, this chunk is ignored and the similarity metrics are set to a low value, such as 0 or a negative number. This can help prevent high similarity values being wrongly generated by dead pixels. The similarity metric is calculated between the flattened template chunks of both the current template and the reference template. Once the similarity metric is calculated, a min-max normalization is performed for the metric and then a heat map is generated, as will be described in more detail below.

In one embodiment, the short-term template matching utilizes the universal image quality index, the Euclidean distance, and the Hamming distance in order to determine an overall similarity metric or to otherwise provide an indication of how similarly the current action is being performed relative to the trained action. The universal image quality index can be calculated as described above. The Euclidean distance measures the straight-line distance between the two matrices and vector space for two matrices A and B, the Euclidean distance can be calculated as the square root of the sum of squared differences between corresponding elements. The Hamming distance calculation calculates the number of positions at which the corresponding elements of two matrices are different. This method is used when the matrices have binary elements or when measuring the similarity between matrices.

In one embodiment, the overall similarity metric S is given by the following formula:

$$S = UQI * w 1 + DE * w 2 + DH * w 3 ,$$

where w1, w2, and w3 are weighting factors, UQI is the universal image quality index, DE is the Euclidean distance, and DH is the Hamming distance. In one example, the training template time is 10 s, of which the 3 s with the highest variance are selected, the inference window time is 3 s, the sampling rate is 30 Hz, w1 is 0.5, w2 is 0.3, w2 is 0.2, and the chunk size is 0.25 s. Other values and methods for calculating an overall similarity metric can be utilized without departing from the scope of the present disclosure.

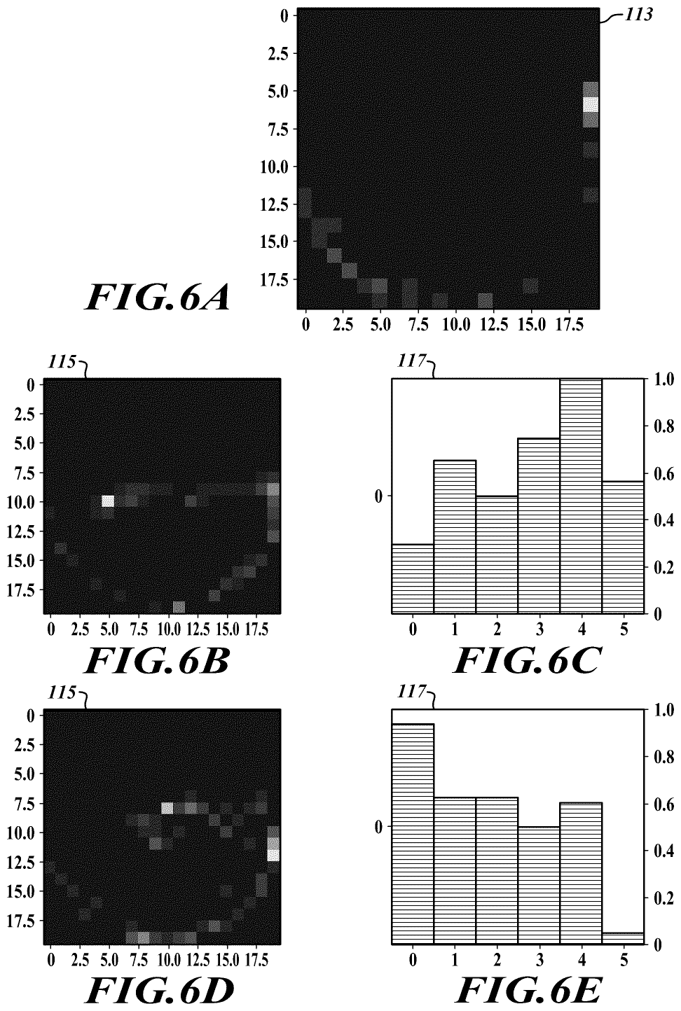

FIG. 5A is a reference template 113 representing a bicep curl after principal component extraction, in accordance with one embodiment. The reference template 113 is generated as described above. FIG. 5B is a current template 115 of a bicep curl. The current template 115 of FIG. 5B represents a relatively good match for the reference template of the bicep curl. FIG. 5C is a bar graph 117 representation of a heat map for 0.5 second chunks of the three seconds of the inference window (six chunks) for the current template 115 of FIG. 5B and the reference template 113 of FIG. 5A. The height of the bar for each chunk represents the similarity of that reference template chunk to the corresponding current template chunk. A higher value corresponds to greater similarity. As can be seen in FIG. 5C, most of the chunks have a high similarity. While FIG. 5C is represented as a bar graph, in practice, a heat map may include color coding with different colors representing different levels of similarity.

FIG. 5D represents a current template 115 of a bicep curl. The current template 115 of FIG. 5D represents a poor match because the bicep curl was performed too fast. FIG. 5E is a bar graph representing a heat map between the current template 115 of FIG. 5D and the reference template 113 of FIG. 5A. As can be seen, most of the chunks in the bar graph 117 of FIG. 5E have low similarity values.

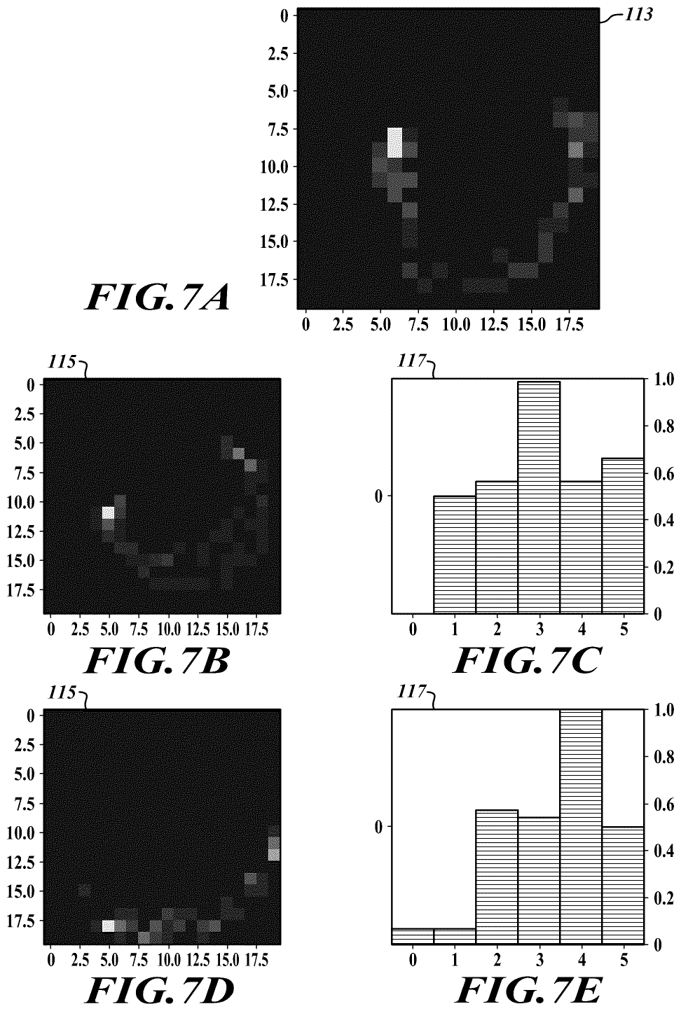

FIG. 6A is a reference template 113 representing a bicep curl after principal component extraction, in accordance with one embodiment. The reference template 113 is generated as described above. FIG. 6B is a current template 115 of a bicep curl. The current template 115 of FIG. 6B represents a relatively bad match for the reference template of the bicep curl. FIG. 6C is a bar graph 117 representation of a heat map for the current template 115 of FIG. 6B and the reference template 113 of FIG. 6A.

FIG. 6D represents a current template 115 of a bicep curl. The current template 115 of FIG. 5D represents a poor match of the bicep curl. FIG. 6E is a bar graph representing a heat map between the current template 115 of FIG. 6D and the reference template 113 of FIG. 6A.

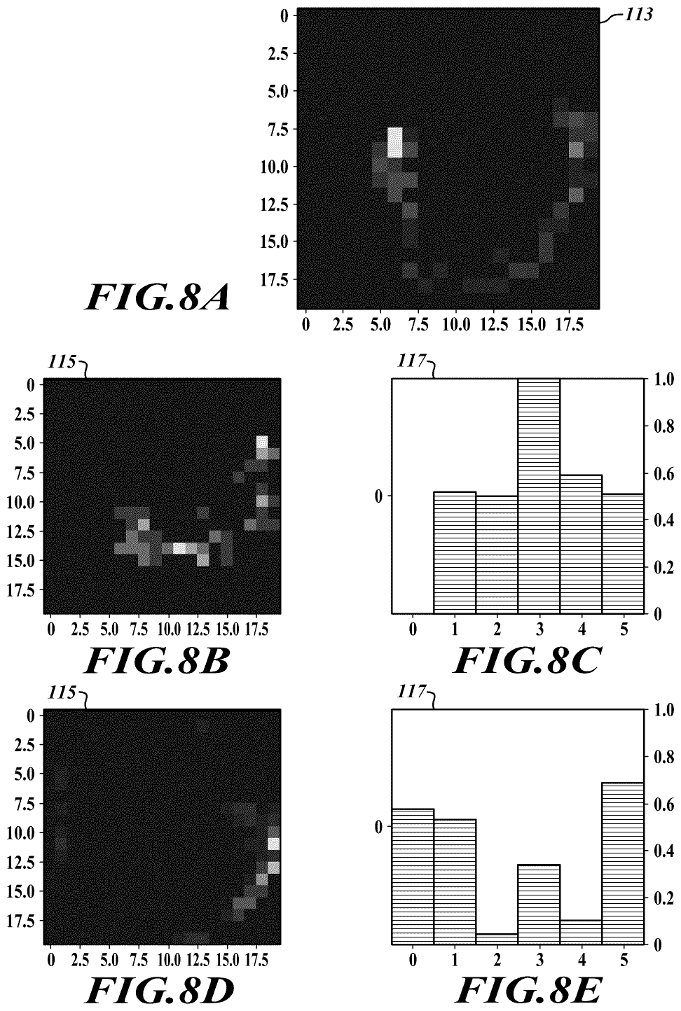

FIG. 7A is a reference template 113 representing a lateral raise after principal component extraction, in accordance with one embodiment. The reference template 113 is generated as described above. FIG. 7B is a current template 115 of a lateral raise. The current template 115 of FIG. 7B represents a relatively good match for the reference template of the lateral raise. FIG. 7C is a bar graph 117 representation of a heat map for the current template 115 of FIG. 7B and the reference template 113 of FIG. 7A.

FIG. 7D represents a current template 115 of a lateral raise. The current template 115 of FIG. 7D represents a poor match of the lateral raise. FIG. 7E is a bar graph representing a heat map between the current template 115 of FIG. 7D and the reference template 113 of FIG. 7A.

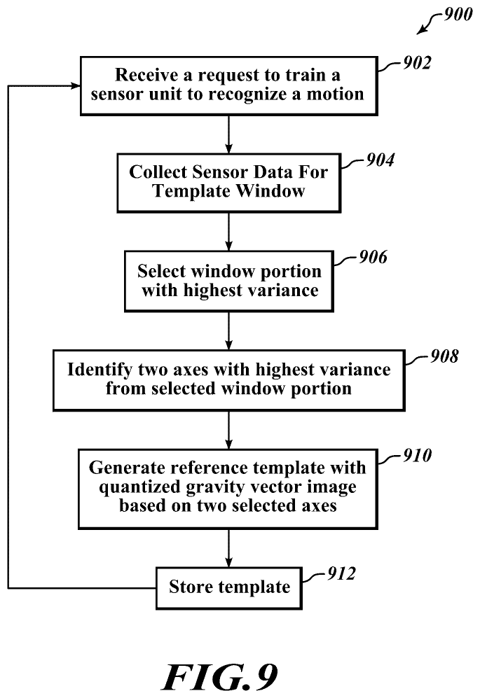

FIG. 8A is a reference template 113 representing a lateral raise after principal component extraction, in accordance with one embodiment. The reference template 113 is generated as described above. FIG. 8B is a current template 115 of a lateral raise. The current template 115 of FIG. 8B represents a relatively poor match for the reference template of the lateral raise. FIG. 8C is a bar graph 117 representation of a heat map for the current template 115 of FIG. 8B and the reference template 113 of FIG. 8A.

FIG. 8D represents a current template 115 of a lateral raise. The current template 115 of FIG. 8D represents a poor match because the lateral raise. FIG. 8E is a bar graph representing a heat map between the current template 115 of FIG. 8D and the reference template 113 of FIG. 8A.

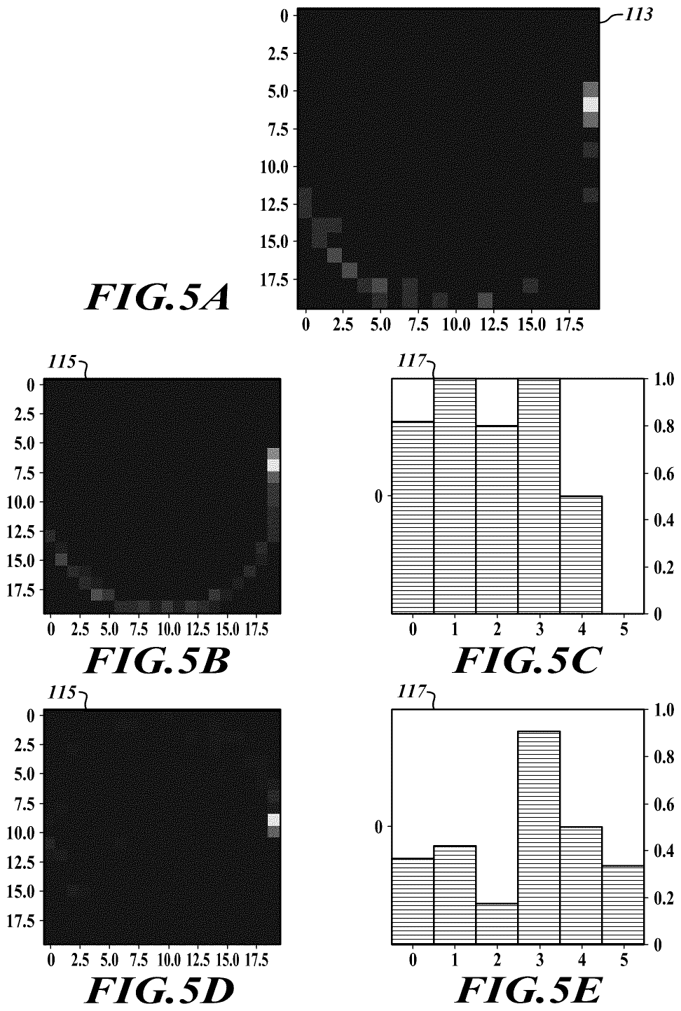

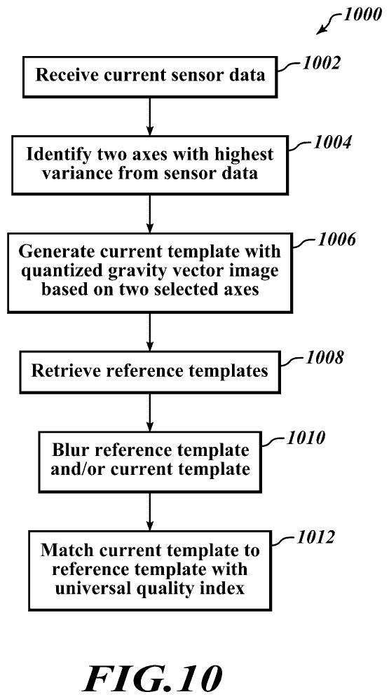

FIG. 9 is a flow diagram of a method 900 for generating a reference template during training of a sensor unit, in accordance with one embodiment. The method 900 can utilize components, systems, and processes described in relation to FIGS. 1-8E. At 902, the method 900 includes receiving a request to train a sensor unit to recognize a motion or activity. At 904, the method 900 generates sensor data for a template window. At 906, the method 900 selects a window portion from the template window having the highest variance. At 908, the method 900 identifies the two axes with the highest variance from the selected window portion. At 910, the method 900 generates a reference template with quantized gravity vector image based on the two selected axes. At 912, the method 900 stores the reference template. From 912, the method 900 can return to 902 to train another motion or activity.

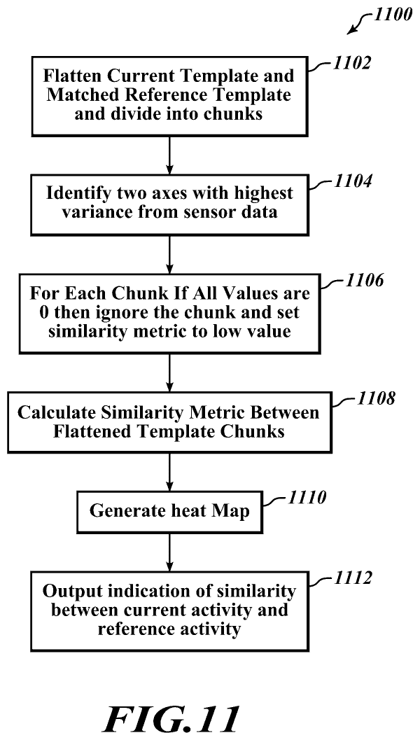

FIG. 10 is a flow diagram of a method 1000 for detecting an activity with a sensor unit, in accordance with one embodiment. The method 1000 can utilize components, systems, and processes described in relation to FIGS. 1-9. At 1002, the method 1000 includes receiving current sensor data. At 1004, the method 1000 includes identifying the two axes with highest variance from the sensor data. At 1006, the method 1000 includes generating a current template with quantized gravity vector image based on the two selected axes. At 1008, the method 1000 includes retrieving one or more reference templates from memory. At 1010, the method 1000 includes learning the reference template and/or the current template. At 1012, the method 1000 includes matching the current template to a reference template with a universal image quality index.

Is a flow diagram of a method 1100 for performing short-term matching of a current activity to a train the activity, in accordance with one embodiment. The method 1100 can utilize components, systems, and processes described in relation to FIGS. 1-10. At 1102, the method includes flattening the current template and the matched reference template and dividing them into chunks. At 1104, the method 1100 includes, for each chunk, if all values are 0, ignoring the chunk and sending the similarity metric to a low value. At 1106, the method 1100 includes calculating a similarity metric between flattened template chunks. At 1108, the method 1100 includes generating a heat map based on the similarity metric for the flattened chunks. At 1110, the method 1100 includes outputting an indication of similarity between the current activity and the reference activity.

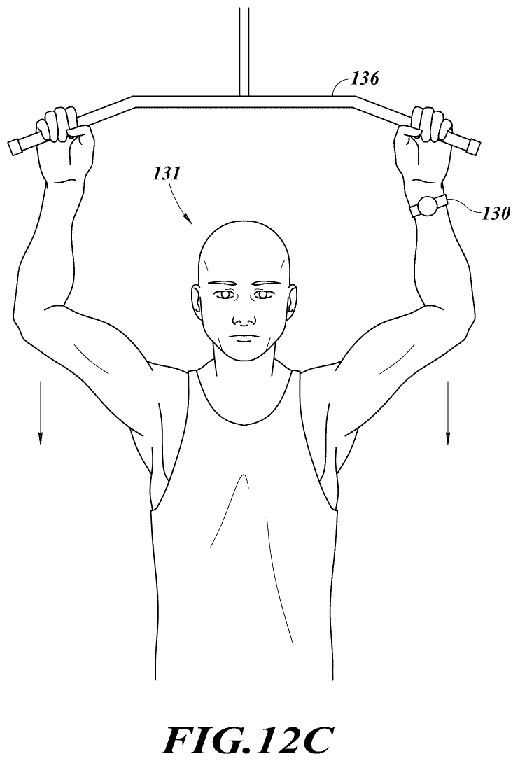

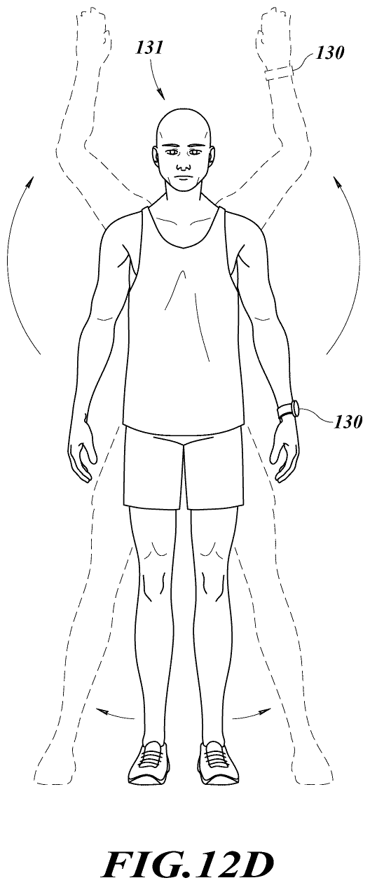

FIG. 12A is an illustration of a smartwatch 130, according to one embodiment. The smartwatch 130 is one example of an electronic device 100 of FIG. 1. Furthermore, the smartwatch 130 is one example of a wearable electronic device. The smartwatch 130 includes a sensor unit 102, as described in relation to previous figures. The smartwatch 130 can be worn on a wrist of the user. As the user performs motions or activities, the sensor unit generates and processes sensor signals. The sensor unit can include an analysis model or algorithm that can be trained to recognize motions or activities of the user and then to make inferences or classifications regarding motions or activities of the user. The sensor unit can also perform short-term template matching, as described above.

FIG. 12B is an illustration of an activity that the smartwatch 130 can be trained to recognize, according to one embodiment. FIG. 12B illustrates the arm 132 of the user holding a dumbbell 134 and performing bicep curls. The sensor unit 102 can be trained with an unsupervised machine learning process to recognize the motion of the bicep curl. The sensor unit 102 can generate a template 900 (shown in FIG. 9E) based on the sensor signals recorded during training.

FIG. 12C is an illustration of an activity that the smartwatch 130 can be trained to recognize, according to one embodiment. FIG. 12C illustrates a user performing a pull-down exercise with a bar 136. The sensor unit 102 can be trained with an unsupervised machine learning process to recognize the motion of the pull-down exercise. The sensor unit 102 can generate a template.

FIG. 12D is an illustration of an activity that the smartwatch 130 can be trained to recognize, according to one embodiment. FIG. 12D illustrates a user performing a jumping jack. The sensor unit 102 can be trained with an unsupervised machine learning process to recognize the motion of the jumping jack. The sensor unit 102 can generate a template based on the sensor signals recorded during training.

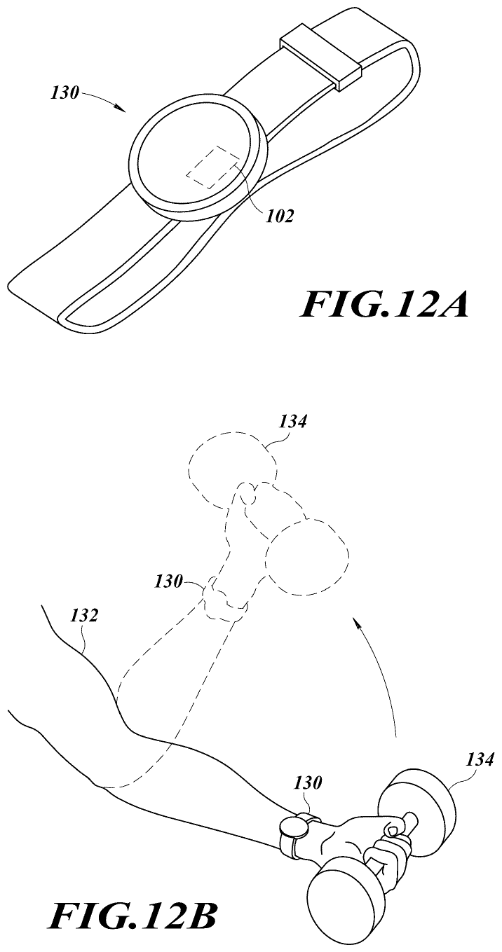

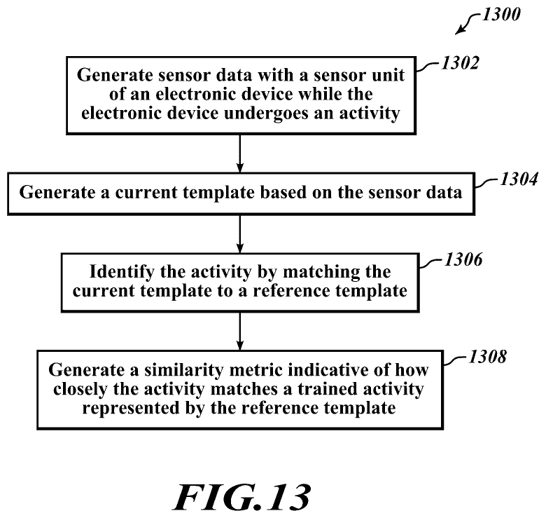

FIG. 13 is a flow diagram of a method 1300 for operating a sensor unit of an electronic device, in accordance with one embodiment. The method 1300 can utilize processes, components, and systems described in relation to FIGS. 1-12D. At 1302, the method 1300 includes generating sensor data with a sensor unit of an electronic device while the electronic device undergoes an activity. At 1304, the method 1300 includes generate a current template based on the sensor data. At 1306, the method 1300 includes identify the activity by matching the current template to a reference template. At 1308, the method 1300 includes generating a similarity metric indicative of how closely the activity matches a trained activity represented by the reference template.

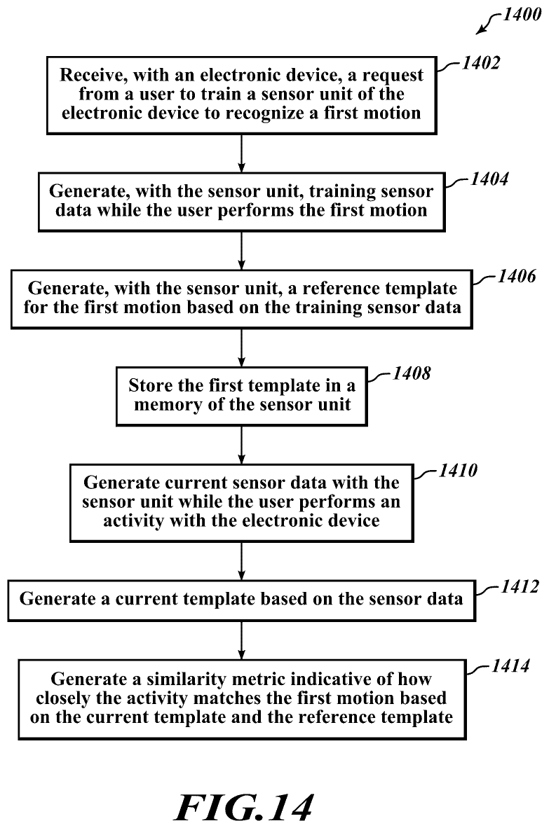

FIG. 14 is a flow diagram of a method 1400 for operating a sensor unit of an electronic device, in accordance with one embodiment. The method 1400 can utilize processes, components, and systems described in relation to FIGS. 1-13. At 1402, the method 1400 includes receiving, with an electronic device, a request from a user of the electronic device to train a sensor unit of the electronic device to recognize a first motion. At 1404, the method 1400 includes generating, with the sensor unit, training sensor data while the user performs the first motion. At 1406, the method 1400 includes generating, with the sensor unit, a reference template for the first motion based on the training sensor data. At 1408, the method 1400 includes storing the first template in a memory of the sensor unit. At 1410, the method 1400 includes generating current sensor data with the sensor unit while the user performs an activity with the electronic device. At 1412, the method 1400 includes generating a current template based on the sensor data. At 1414, the method 1400 includes generating a similarity metric indicative of how closely the activity matches the first motion based on the current template and the reference template.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
generating sensor data with a sensor unit of an electronic device while the electronic device undergoes an activity;
generating a current template based on the sensor data;
identifying the activity based on the current template; and
outputting from the electronic device a rating of performance of the activity.

2. The method of claim 1, wherein generating the current template includes generating a quantized gravity vector image.

3. The method of claim 1, wherein identifying the activity includes matching the current template to a reference template, the method comprising generating an overall similarity metric indicative of how closely the activity matches a trained activity represented by the reference template.

4. The method of claim 3, wherein matching the current template to the reference template includes performing convolutional blurring on either or both of the current template and the reference template.

5. The method of claim 4, wherein matching the current template to the reference template includes generating a universal image quality index score.

6. The method of claim 3, wherein generating the overall similarity metric includes dividing the reference template into n first chunks and diving the current template into n second chunks.

7. The method of claim 6, comprising flattening the current template and the reference template prior to dividing the reference template into first chunks and the current template into second chunks.

8. The method of claim 6, wherein generating the overall similarity metric includes ignoring a first chunk and a corresponding second chunk if all values in both the first chunk and the second chunk are 0.

9. The method of claim 6, wherein generating the overall similarity metric includes generating a similarity sub-metric for each second chunk corresponding to a similarity between each second chunk and a corresponding first chunk.

10. The method of claim 9, wherein generating each similarity sub-metric includes performing a min-max normalization.

11. The method of claim 9, comprising generating a heatmap based on the similarity sub-metrics.

12. The method of claim 3, wherein generating the overall similarity metric includes generating a Euclidean distance.

13. The method of claim 3, wherein generating the overall similarity metric includes generating a Hamming distance.

14. The method of claim 3, wherein generating the overall similarity metric includes generating a Euclidean distance, a Hamming distance, and a universal image quality index score.

15. The method of claim 13, comprising generating the overall similarity metric with a weighted sum of the Euclidean distance, the Hamming distance, and the universal image quality index score, wherein each weight associated with the weighted sum can be tuned.

16. The method of claim 1, wherein generating sensor data includes generating sensor data for each of three or more axes, wherein generating the current template includes selecting two axes having a highest variance and generating the current template from the sensor data of the two axes having the highest variance.

17. A method, comprising:
receiving, with an electronic device, a request from a user of the electronic device to train a sensor unit of the electronic device to recognize a first motion;
generating, with the sensor unit, training sensor data while the user performs the first motion;
generating, with the sensor unit, a reference template for the first motion based on the training sensor data;
storing the first template in a memory of the sensor unit;
generating current sensor data with the sensor unit while the user performs an activity with the electronic device;
generating a current template based on the current sensor data; and
generating a similarity metric indicative of how closely the activity matches the first motion based on the current template and the reference template.

18. The method of claim 17, comprising, prior to generating the similarity metric, identifying the activity by matching the current template to a reference template.

19. The method of claim 18, wherein matching the current template to the reference template includes performing convolutional blurring on either or both of the current template and the reference template.

20. The method of claim 17, wherein generating the overall similarity metric includes dividing the reference template into n first chunks and diving the current template into n second chunks and generating a heatmap based on the first chunks and the second chunks.

21. An electronic device, comprising:
a user input;
a display; and
a sensor unit including a sensor, wherein the sensor unit is configured to:
generate sensor data while the electronic device undergoes an activity;
generate a current template based on the sensor data;
identify the activity by matching the current template to a reference template stored in the sensor unit; and
perform short-term activity matching including determining, based on the reference template and the current template, how closely the activity matches a trained activity represented by the reference template.

22. The electronic device of claim 21, wherein the sensor includes an accelerometer.

23. The electronic device of claim 21, wherein the sensor unit is configured to:
receive, via the user input, a request from a user of the electronic device to learn the activity;
generate training sensor data while the user performs the activity; and
generate the reference template based on the training sensor data.

24. The electronic device of claim 21, wherein the electronic device is a smart watch, smart glasses, a mobile phone, or a heart rate monitor.
